(19) United States
(12) Patent Application Publication
(10) Pub. No.: US 2015/0370721 A1
(43) Pub. Date: Dec. 24, 2015

(54) MAPPING MECHANISM FOR LARGE SHARED ADDRESS SPACES

(71) Applicant: HEWLETT-PACKARD DEVELOPMENT COMPANY, L.P., Houston, TX (US)

(72) Inventors: Dale C. Morris, Steamboat Springs, CO (US); Russ W. Herrell, Fort Collins, CO (US); Gary Gostin, Plano, TX (US); Robert J. Brooks, Fort Collins, CO (US)

(21) Appl. No.: 14/764,922

(22) PCT Filed: Jan. 31, 2013
(86) PCT No.: PCT/US2013/024223

§ 371 Date: Jul. 30, 2015

(51) Int. Cl. G06F 12/10; G06F 12/06

(52) U.S. Cl. CPC G06F 12/10; G06F 12/06; G06F 2212/1052; G06F 2212/656

(57) ABSTRACT

The present disclosure provides techniques for mapping large shared address spaces in a computing system. A method includes creating a physical address map for each node in a computing system. Each physical address map maps the memory of a node. Each physical address map is copied to a single address map to form a global address map that maps all memory of the computing system. The global address map is shared with all nodes in the computing system.

### CROSS-REFERENCE TO RELATED APPLICATION

Pursuant to 35 U.S.C. §371, this application is a United States National Stage application of International Patent Application No. PCT/US2013/024223, filed on Jan. 31, 2013, the contents of which are incorporated by reference as if set forth in their entirety herein.

### BACKGROUND

Computing systems, such as data centers, include multiple nodes. The nodes include compute nodes and storage nodes. The nodes are communicably coupled and can share memory storage between nodes to increase the capabilities of individual nodes.

### BRIEF DESCRIPTION OF THE DRAWINGS

Certain exemplary embodiments are described in the following detailed description and in reference to the drawings, in which:

FIG. 1 is a block diagram of an example of a computing system;

FIG. 2 is an illustration of an example of the composition of a global address map;

FIG. 3 is a process flow diagram illustrating an example of a method of mapping shared memory address spaces; and

FIG. 4 is a process flow diagram illustrating an example of a method of accessing a stored data object.

### DETAILED DESCRIPTION OF SPECIFIC EMBODIMENTS

Embodiments disclosed herein provide techniques for mapping large, shared address spaces. Generally, address-space objects, such as physical memory and IO devices, are dedicated to a particular compute node, such as by being physically present on the interconnect board of the compute node, wherein the interconnect board is the board, or a small set of boards, containing the processor or processors that make up the compute node. A deployment of compute nodes, such as in a data center, can include large amounts of memory and IO devices, but the partitioning of these with portions physically embedded in, and dedicated to, particular compute nodes is inefficient and poorly suited to computing problems that require huge amounts of data and large numbers of compute nodes working on that data. Rather than compute nodes simply referencing the data they need, the compute nodes constantly engage in inter-node communication to get at the memory containing the data. Alternatively, the data may be kept strictly on shared storage devices (such as hard disk drives), rather than in memory, significantly increasing the time to access those data and lowering overall performance.

One trend in computing deployments, particularly in data centers, is to virtualize the compute nodes, allowing for, among other things, the ability to move a virtual compute node and the system environment and workloads it is running, from one physical compute node to another. The virtual compute node is moved for purposes of fault tolerance and power-usage optimization, among others. However, when moving a virtual compute node, the data in memory in the source physical compute node is also moved (i.e., copied) to memory in the target compute node. Moving the data uses considerable resources (e.g., energy) and often suspends execution of the workloads in question while this data transfer takes place.

In accordance with the techniques described herein, memory storage spaces in the nodes of a computing system are mapped to a global address map accessible by the nodes in the computing system. The compute nodes are able to directly access the data in the computing system, regardless of the physical location of the data within the computing system, by accessing the global address map. By storing the data in fast memory while allowing multiple compute nodes to directly access the data as needed, the time to access data and overall performance may be improved. In addition, by storing the data in memory in a shared pool of memory, significant amounts of which can be persistent memory, akin to storage, and mapping the data into the source compute node, the virtual-machine migrations can occur without copying data. Furthermore, since the failure of a compute node does not prevent its memory in the global address map from simply being mapped to another node, additional fail-over approaches are enabled.

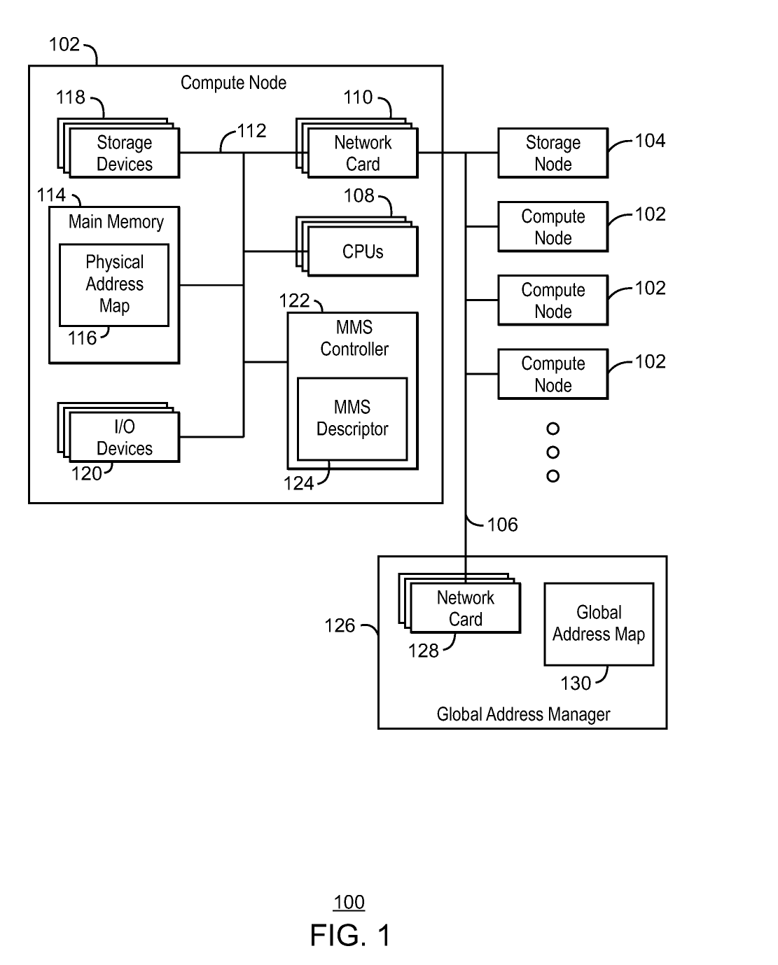

FIG. 1 is a block diagram of an example of a computing system, such as a data center. The computing system 100 includes a number of nodes, such as compute node 102 and storage node 104. The nodes 102 and 104 are communicably coupled to each other through a network 106 such as a data center fabric. The computing system 100 can include several compute nodes, such as several tens or even thousands of compute nodes.

The compute nodes 102 include a Central Processing Unit (CPU) 108 to execute stored instructions. The CPU 108 can be a single core processor, a multi-core processor, or any other suitable processor. In an example, compute node 102 includes a single CPU. In another example, compute node 102 includes multiple CPUs, such as two CPUs, three CPUs, or more.

The compute nodes 102 also include a network card 110 to connect the compute node 102 to a network. The network card 110 may be communicatively coupled to the CPU 108 via bus 112. The network card 110 is an IO device for networking, such as a network interface controller (NIC), a converged network adapter (CNA), or any other device providing the compute node 102 with access to a network. In an example, the compute node 102 includes a single network card. In another example, the compute node 102 includes multiple network cards. The network can be a local area network (LAN), a wide area network (WAN), the internet, or any other network.

The compute node 102 includes a main memory 114. The main memory is volatile memory, such as random access memory (RAM), dynamic random access memory (DRAM), read only memory (ROM), or any other suitable memory system. A physical memory address map (PA) 116 is stored in the main memory 114. The PA 116 is a system of file system tables and pointers which maps the storage spaces of the main memory.

Compute node 102 also includes a storage device 118 in addition to the main memory 114. The storage device 118 is non-volatile memory such as a hard drive, an optical drive, a solid-state drive such as a flash drive, an array of drives, or any other type of storage device. The storage device may also include remote storage.

Compute node 102 includes Input/Output (IO) devices 120. The IO devices 120 include a keyboard, mouse, printer, or any other type of device coupled to the compute node. Portions of main memory 114 may be associated with the IO devices 120 and the IO devices 120 may each include memory within the devices. IO devices 120 can also include IO storage devices, such as a fiber channel storage area network (FC SAN), a small computer system interface direct-attached storage (SCSi DAS), or any other suitable IO storage devices or combinations of storage devices.

Compute node 102 further includes a memory mapped storage (MMS) controller 122. The MMS controller 122 makes persistent memory on storage devices available to the CPU 108 by mapping all or some of the persistent storage capacity (i.e., storage devices 118 and IO devices 120) into the PA 116 of the node 102. Persistent memory is non-volatile storage, such as storage on a storage device. In an example, the MMS controller 122 stores the memory map of the storage device 118 on the storage device 118 itself and a translation of the storage device memory map is placed into the PA 116. Any reference to persistent memory can thus be directed through the MMS controller 122 to allow the CPU 108 to access persistent storage as memory.

The MMS controller 122 includes an MMS descriptor 124. The MMS descriptor 124 is a collection of registers in the MMS hardware that set up the mapping of all or a portion of the persistent memory into PA 116.

Computing device 100 also includes storage node 104. Storage node 104 is a collection of storage, such as a collection of storage devices, for storing a large amount of data. In an example, storage node 104 is used to backup data for computing system 100. In an example, storage node 104 is an array of disk drives. In an example, computing device 100 includes a single storage node 104. In another example, computing device 100 includes multiple storage nodes 104. Storage node 104 includes a physical address map mapping the storage spaces of the storage node 104.

Computing system 100 further includes global address manager 126. In an example, global address manager 126 is a node of the computing system 100, such as a compute node 102 or storage node 104, designated to act as the global address manager 126 in addition to the node's computing and/or storage activities. In another example, global address manager 126 is a node of the computing system which acts only as the global address manager.

Global address manager 126 is communicably coupled to nodes 102 and 104 via connection 106. Global address manager 126 includes network card 128 to connect global address manager 126 to a network, such as connection 106. Global address manager 126 further includes global address map 130. Global address map 130 maps all storage spaces of the nodes within the computing system 100. In another example, global address map 130 maps only the storage spaces of the nodes that each node elects to share with other nodes in the computing system 100. Large sections of each node local main memory and IO register space may be private to the node and not included in global address map 130. All nodes of computing system 100 can access global address map 130. In an example, each node stores a copy of the global address map 130 which is linked to the global address map 130 so each copy is updated when the global address map 130 is updated. In another example, the global address map 130 is stored by the global address manager 126 and accessed by each node in the computing system 100 at will. A mapping mechanism maps portions of the global address map 130 to the physical address maps 116 of the nodes. The mapping mechanism can be bidirectional and can exist within remote memory as well as on a node. If a compute node is the only source of transactions between the compute node and the memory or IO devices and if the PA and the global address map are both stored within the compute node, the mapping mechanism is unidirectional.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

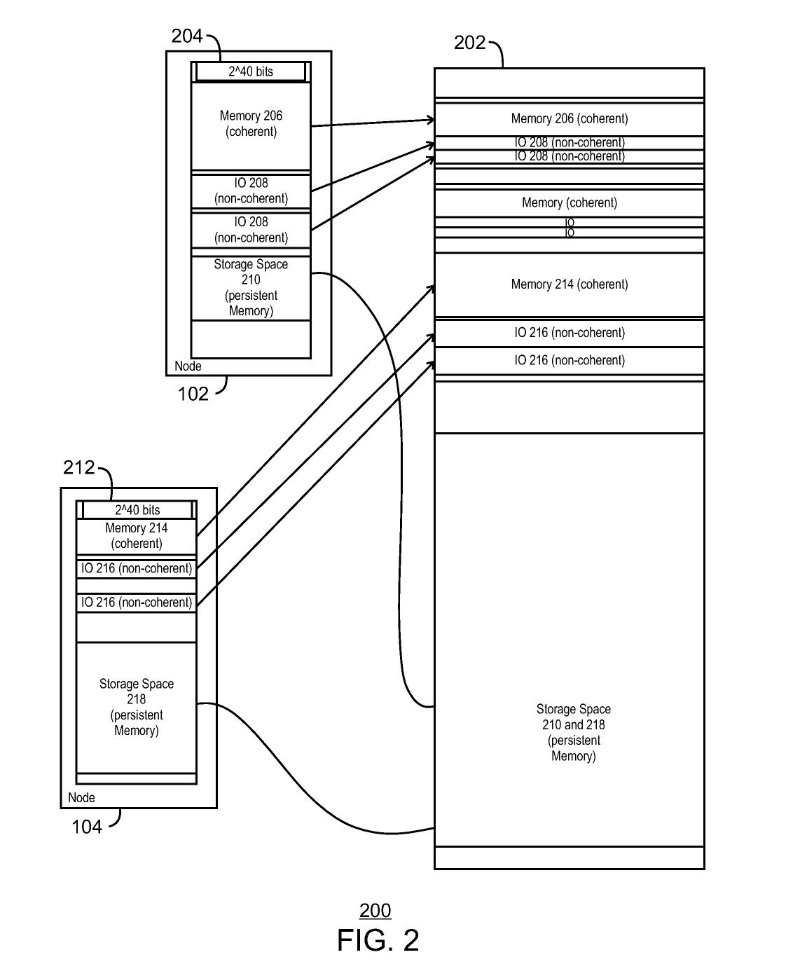

FIG. 2 is an illustration of an example of the composition of a global address map 202. Node 102 includes a physical address map (PA) 204. Node 102 is a compute node of a computing system, such as computing system 100. PA 204 maps all storage spaces of the memory of node 102, including main memory 206, IO device memory 208, and storage 210. PA 204 is copied in its entirety to global address map 202. In another example, PA 204 maps only the elements of node 102 that the node 102 shares with other nodes to the global address map 202. Large sections of node local main memory and IO register space may be private to PA 204 and not included in global address map 202.

Node 104 includes physical address map (PA) 212. Node 104 is a storage node of a computing system, such as computing system 100. PA 212 maps all storage spaces of the memory of node 104, including main memory 214, IO device storage 216, and storage 218. PA 212 is copied to global address map 202. In another example, PA 212 maps only the elements of node 104 that the node 104 shares with other nodes to the global address map 202. Large sections of node local main memory and IO register space may be private to PA 212 and not included in global address map 202.

Global address map 202 maps all storage spaces of the memory of the computing device. Global address map 202 may also include storage spaces not mapped in a PA. Global address map 202 is stored on a global address manager included in the computing device. In an example, the global address manager is a node, such as node 102 or 104, which is designated as the global address manager in addition to the node's computing and/or storage activities. In another example, the global address manager is a dedicated node of the computing system.

Global address map 202 is accessed by all nodes in the computing device. Storage spaces mapped to the global address map 202 can be mapped to any PA of the computing system, regardless of the physical location of the storage space. By mapping the storage space to the physical address of a node, the node can access the storage space, regardless of whether the storage space is physically located on the node. For example, node 102 maps memory 214 from global address map 202 to PA 204. After memory 214 is mapped to PA 204, node 102 can access memory 214, despite the fact that memory 214 physically resides on node 104. By enabling nodes to access all memory in a computing system, a shared pool of memory is created. The shared pool of memory is a potentially huge address space and is unconstrained by the addressing capabilities of individual processors or nodes.

Storage spaces are mapped from global address map 202 to a PA by a mapping mechanism included in each node. In an example, the mapping mechanism is the MMS controller. The size of the PA supported by CPUs in a compute node constrains how much of the shared pool of memory can be mapped into the compute node's PA at any given time, but it does not constrain the total size of the pool of shared memory or the size of the global address map.

In some examples, a storage space is mapped from the global address map 202 statically, i. e., memory resources are provisioned when a node is booted, according to the amount of resources needed. Rather than deploying some nodes with larger amounts of memory and others with smaller amounts of memory, and some nodes with particular IO devices, and other with a different mix of IO devices, and combinations thereof, generic compute nodes can be deployed. Instead of having to choose from an assortment of such pre-provisioned systems with the attendant complexity and inefficiency, by creating a pool of shared memory and a global address map and programming the mapping mechanism in the compute node to map the memory and IO into that compute node's PA, a generic compute node with the proper amount of memory and IO devices can be provisioned into a new server.

In another example, a storage space is mapped from the global address map 202 dynamically, meaning that a running operating environment on a node requests access to a resource in shared memory that is not currently mapped into the node's PA. The mapping can be added to the PA of the node during running of the operating system. This mapping is equivalent to adding additional memory chips to a traditional compute node's board while it is running an operating environment. Memory resources no longer needed by a node are relinquished and freed for use by other nodes, simply by removing the mapping for that memory resource from the node's PA. The address-space-based resources (i.e., main memory, storage devices, memory-mapped IO devices) for a given server instance can flex dynamically, growing and shrinking as needed by the workloads on that server instance.

In some examples, not all memory spaces are mapped from shared memory. Rather, a fixed amount of memory is embedded within a node while any additional amount of memory needed by the node is provisioned from shared memory by adding a mapping to the node's PA. IO devices may operate in the same manner.

In addition, by creating a pool of shared memory, virtual machine migration can be accomplished without moving memory from the original compute node to the new compute node. Currently for virtual-machine migration, data in memory is pushed out to storage before migrating and pulled back into memory on the target physical compute node after the migration. However, this method is inefficient and takes a great deal of time. Another approach is to over-provision the network connecting compute nodes to allow memory to be copied over the network from one compute node to another in a reasonable amount of time. However, this over-provisioning of network bandwidth is costly and inefficient and may prove impossible for large memory instances.

However, by creating a pool of shared memory and mapping the pool of shared memory in a global address map, the PA of the target node of a machine migration from a source compute node is simply programmed with the identical mappings as in the source node PA, obviating the need for copying or moving any of the data in memory mapped in the global address map. What little state is present in the source compute node itself can therefore be moved to the target node quickly, allowing for an extremely fast and efficient migration.

In the case of machine migration or dynamic remapping, fabric protocol features ensure that appropriate handling of in-flight transactions occurs. One method for accomplishing this handling is to implement a cache coherence protocol similar to that employed in symmetric multiprocessors or CC-NUMA systems. Alternatively, coarser-grained solutions that operate at the page or volume level and require software involvement can be employed. In this case, the fabric provides a flush operation that returns an acknowledgement after in-flight transactions reach a point of common visibility. The fabric also supports write-commit semantics, as applications sometimes need to ensure that written data has reached a certain destination such that there is sufficient confidence of data survival, even in the case of severe failure scenarios.

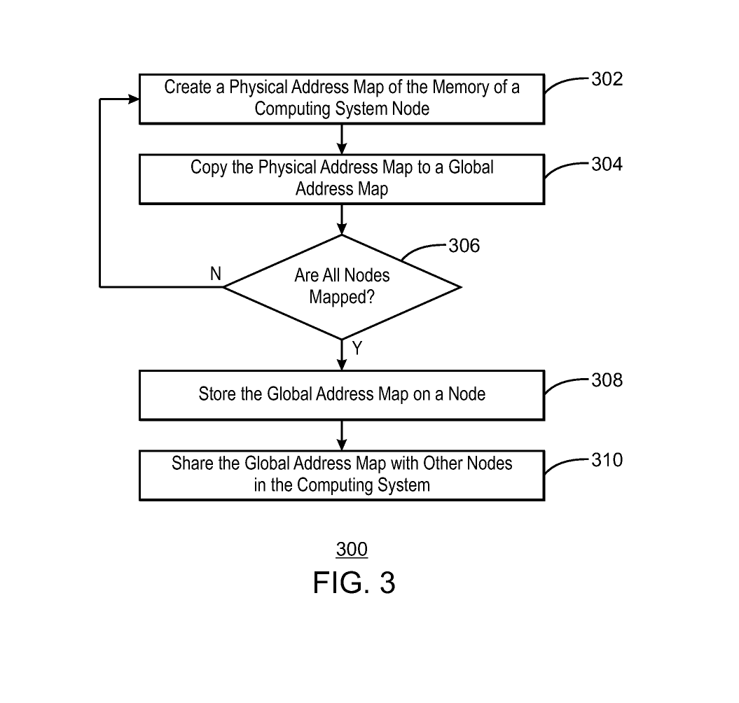

FIG. 3 is a process flow diagram illustrating a method of mapping shared memory address spaces. The method 300 begins at block 302. At block 302, a physical address map of the memory in a node is created. The node is included in a computing system and is a compute node, a storage node, or any other type of node. The computing system includes multiple nodes. In an example, the nodes are all one type of node, such as compute nodes. In another example, the nodes are mixtures of types. The physical address map maps the memory spaces of the node, including the physical memory and the IO device memory. The physical address map is stored in the node memory.

At block 304, some or all of the physical address map is copied to a global address map. The global address map maps some or all memory address spaces of the computing device. The global address map may map memory address spaces not included in a physical address map. The global address map is accessible by all nodes in the computing device. An address space can be mapped from the global address map to the physical address map of a node, providing the node with access to the address space regardless of the physical location of the address space, i.e. regardless of whether the address space is located on the node or another node. Additional protection attributes may be assigned to sub-ranges of the global address map such that only specific nodes may actually make use of the sub-ranges of the global mapping.

At block 306, a determination is made if all nodes have been mapped. If not, the method 300 returns to block 302. If yes, at block 308 the global address map is stored on a global address manager. In an example, the global address manager is a node designated as the global address manager in addition to the node's computing and/or storage activities. In another example, the global address manager is a dedicated global address manager. The global address manager is communicably coupled to the other nodes of the computing system. In an example, the computing system is a data center. At block 310, the global address map is shared with the nodes in the computing system. In an example, the nodes access the global address map stored on the global address manager. In another example, a copy of the global address map is stored in each node of the computing system and each copy is updated whenever the global address map is updated.

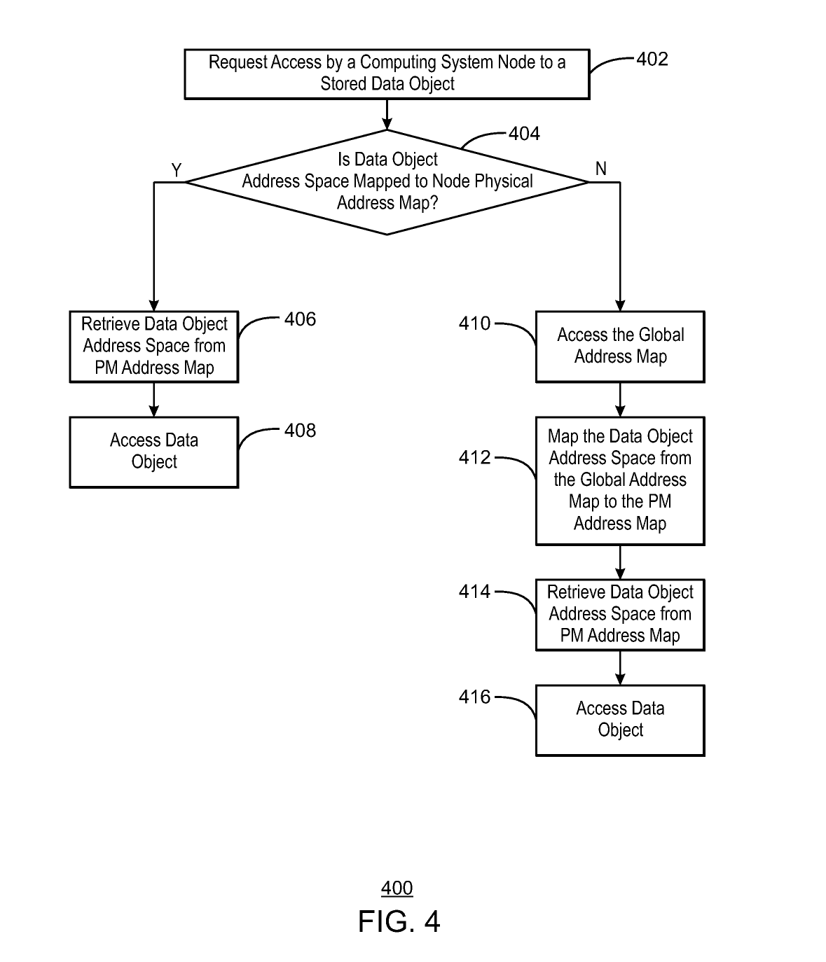

FIG. 4 is a process flow diagram illustrating a method of accessing a stored data object. At block 402, a node of a computing system requests access to a stored data object. In an example, the node is a compute node, such as compute nodes 102 and 104. The computing system, such as computing system 100, can include multiple nodes and the multiple nodes can share memory to create a pool of shared memory. In an example, each node is a compute node including a physical memory. The physical memory includes a physical memory address map. The physical memory address map maps all storage spaces within the physical memory and lists the contents of each storage space.

At block 404, the node determines if the address space of the data object is mapped in the physical memory address map. If the address space is mapped in the physical memory address map, then at block 406 the node retrieves the data object address space from the physical memory address map. At block 408, the node accesses the stored data object.

If the address space of the data object is not mapped in the physical memory address map, then at block 410 the node accesses the global address map. The global address map maps all shared memory in the computing system and is stored by a global address manager. The global address manager can be a node of the computing device designated to act as the global address manager in addition to the node's computing and/or storage activities. In an example, the global address manager is a node dedicated only to acting as global address manager. At block 412, the data object address space is mapped to the physical memory address map from the global address map. In an example, a mapping mechanism stored in the node performing the mapping. The data object address space may be mapped from the global address map to the physical address map statically or dynamically. At block 414, the data object address space is retrieved from the physical memory address map. At block 416, the stored data object is accessed by the node.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method, comprising:
creating a physical address map for each node in a computing system, each physical address map mapping the memory of a node;
copying all or part of each physical address map to a single address map to form a global address map that maps the shared memory of the computing system;
and sharing the global address map with the nodes in the computing system.

2. The method of claim 1, further comprising copying an address space from the global address map to a physical address map of a node.

3. The method of claim 2, further comprising the node accessing the address space regardless of the physical location of the address space.

4. The method of claim 1, wherein the nodes are compute nodes, storage nodes, or a mixture of compute nodes and storage nodes.

5. The method of claim 1, wherein the global address map maps memory not included in a physical address map.

6. The method of claim 5, wherein the global address map is stored in a node of the computing device, the node designated to act as a global address manager.

7. A computing system, comprising:
at least two nodes communicably coupled to each other, each node comprising:
a mapping mechanism; and
a memory mapped by a physical address map, some of the memory of each node shared between nodes to form a pool of memory; and
a global address map to map the pool of memory,
wherein the mapping mechanism maps an address space of the global address map to the physical memory map.

8. The system of claim 7, wherein the pool of memory comprises one of physical memory, IO storage devices, or a combination of physical memory and IO storage devices.

9. The system of claim 7, wherein the nodes comprise one of a compute node, a storage node, or a compute node and a storage node.

10. A memory mapping system, comprising:
a global address map mapping a pool of memory shared between computing system nodes; and
a mapping mechanism to map a shared address space from the global address map to a physical address map of a node.

11. The memory mapping system of claim 10, wherein the physical memory address map maps storage spaces of a node memory, the memory comprising one of physical memory, IO storage devices, or a combination of physical memory and IO storage devices.

12. The memory mapping system of claim 10, wherein the global address map is stored by a global address manager, the global address manager comprising a computing system node.

13. The memory mapping system of claim 10, wherein the pool of shared memory is shared between one of compute nodes, storage nodes, or a combination of compute nodes and storage nodes.

14. The memory mapping system of claim 10, wherein the memory mapping system permits a node to access a memory storage space, regardless of the physical location of the memory storage space.

15. The memory mapping system of claim 10, wherein a node hosting the shared address space controls access to the shared address space by another node, the node hosting the shared address space granting or denying accessing to the shared address space.
